(19) United States
(12) Patent Application Publication
(10) Pub. No.: US 2006/0116486 A1
(43) Pub. Date: Jun. 1, 2006

(54) Polyacetal resin composition

(75) Inventors: Tomohiro Monma, Fuji-shi (JP); Sachio Anada, Fuji-shi (JP); Hiraku Iketani, Fuji-shi (JP)

Correspondence Address: NIXON & VANDERHYE, PC, 901 NORTH GLEBE ROAD, 11TH FLOOR, ARLINGTON, VA, 22203, US

(73) Assignee: Polyplastics Co., Ltd.,, Tokyo (JP)

(21) Appl. No.: 11/287,296

(22) Filed: Nov. 28, 2005

(30) Foreign Application Priority Data
Nov. 29, 2004 (JP) 2004-343783

(51) Int. Cl. C08L 61/02; C08L 61/00

(52) U.S. Cl. 525/398

(57) ABSTRACT

An object of the present invention is to provide a polyacetal resin composition having excellent friction and abrasion characteristics and having improved mechanical strength. Specifically, there are blended (A1) 100 parts by weight of a polyacetal resin having substantially straight chain molecular structure; (A2) 0.1 to 20 parts by weight of a polyacetal resin having branched or crosslinked molecular structure; and (B) 0.05 to 20 parts by weight of a lubricant oil keeping liquid state at 200° C.

### TECHNICAL FIELD

The present invention relates to a polyacetal resin composition having excellent friction and abrasion characteristics and having improved mechanical strength.

### BACKGROUND ART

Polyacetal resins have balanced mechanical properties and excellent anti-friction and anti-abrasion characteristics, resistance to chemicals, resistance to heat, electric characteristics, and the like. Owing to these advantageous characteristics, polyacetal resins are used in wide fields such as automobile, electric or electronic products. The requested characteristics in these fields, however, are upgrading than ever, and, for example, the resin materials are wanted to have further improved sliding characteristics while maintaining the excellent mechanical characteristics and the like. There are known methods to improve the sliding characteristics, such as the one to add a fluororesin or a polyolefin-based resin to a polyacetal resin, (JP-A 7-133403 and JP-A 8-124326), the one to add a fatty acid ester thereto, (JP-A 9-286897), the one to add silicone thereto, (JP-A 5-295230 and JP-A 10-298402), and the one to add a lubricant oil such as various kinds of mineral oils thereto.

### DISCLOSURE OF THE INVENTION

Although the addition of fluororesin and polyolefin-based resin improves the sliding characteristics of polyacetal resin to some extent, those kinds of different resins are poor in compatibility to the polyacetal resin, and cause the deterioration of mechanical characteristics such as tensile strength. The addition of lubricant oil such as fatty acid ester, silicone or various mineral oils generally deteriorates the mechanical characteristics of the polyacetal resin, and further the addition thereof may deteriorate the moldability caused by oozing out thereof during molding stage. Consequently, although the known methods perform the improvement in the sliding characteristics of polyacetal resin, they have not fully satisfied other mechanical characteristics. To this point, materials that improved these insufficient properties are wanted.

The inventors of the present invention carried out intensive studies to obtain a polyacetal resin composition that answers the request, and found that the addition of a specific lubricant and a modified polyacetal resin having branched or crosslinked molecular structure to a polyacetal resin provides a polyacetal resin composition having excellent friction and abrasion characteristics and having improved mechanical characteristics, thus completed the present invention.

That is, the present invention relates to a polyacetal resin composition composed of: 100 parts by weight of (A1) polyacetal resin having substantially straight chain molecular structure; 0.1 to 20 parts by weight of (A2) polyacetal resin having branched or crosslinked molecular structure; and 0.05 to 20 parts by weight of (B) lubricant oil keeping liquid state at 200° C.

### DETAIL DESCRIPTION OF THE INVENTION

The present invention provides a polyacetal resin composition that has excellent friction and abrasion characteristics and has improved mechanical characteristics.

The structure of the present invention is described in the following. The (A1) polyacetal resin having substantially straight chain molecular structure according to the present invention is a polymer which has oxymethylene group (—CH₂O—) as the main structural unit. The polymer may be any of polyacetal homopolymer and polyacetal copolymer (including block copolymer) containing small amount of structural unit other than oxymethylene group, and may be a blend of two or more kinds of polyacetal resins having different characteristics from each other. From the point of moldability and thermal stability, however, polyacetal copolymer is preferred.

A preferable polyacetal copolymer is the one which is prepared by copolymerizing 99.95 to 80.0% by weight of (a) trioxane with 0.05 to 20.0% by weight of (b) compound selected from a cyclic ether compound having no substituent and a cyclic formal compound having no substituent, and more preferably the one which is prepared by copolymerizing 99.9 to 90.0% by weight of (a) trioxane with 0.1 to 10.0% by weight of the (b) compound.

The melt index of the polyacetal copolymer is preferably in a range from 1 to 50 g/min (determined at 190° C. and 2.16 kg of load).

Examples of the comonomer component (above compound (b)) used for manufacturing the polyacetal copolymer are ethylene oxide, 1,3-dioxolane, diethylene glycol formal, 1,4-butanediol formal, 1,3-dioxane, and propylene oxide. As of these, specifically preferred ones are one or more compounds selected from the group consisting of ethylene oxide, 1,3-dioxolane, 1,4-butanediol formal, and diethylene glycol formal. The method for preparing the (A1) polyacetal resin is not specifically limited, and known methods can be applied.

The (A2) polyacetal resin having branched or crosslinked molecular structure according to the present invention is prepared, in the manufacture process of above-described polyacetal homopolymer or polyacetal copolymer, by copolymerization adding a compound which is copolymerizable with formaldehyde, trioxane, or the like and which can form branched unit or crosslinked unit through the copolymerization. For example, on copolymerizing (a) trioxane and (b) compound which is selected from a cyclic ether compound having no substituent and a cyclic formal compound having no substituent, a monofunctional glycidyl compound having a substituent, (for example, phenylglycidylether and butylglycidylether), is further added to conduct copolymerization, thereby attaining a polyacetal resin having branched molecular structure, and furthermore, a polyfunctional glycidylether compound is added to conduct copolymerization to attain a polyacetal resin having crosslinked molecular structure. According to the present invention, a preferable polyacetal resin (A2) is the one having crosslinked molecular structure. As of these (A2) polyacetal resins having crosslinked molecular structure, a preferable one is prepared by copolymerizing 99.89 to 88.0% by weight of (a) trioxane, 0.1 to 10.0% by weight of (b) compound selected from a monofunctional cyclic ether compound having no substituent and monofunctional cyclic formal compound having no substituent, and 0.01 to 2.0% by weight of (c) polyfunctional glycidylether compound, and particularly preferable one is prepared by copolymerizing 99.28 to 96.50% by weight of (a) trioxane, 0.7 to 3.0% by weight of (b) compound, and 0.02 to 0.5% by weight of (c) polyfunctional glycidylether compound. A crosslinked polyacetal resin having melt indexes ranging from 0.1 to 10 g/min is preferred.

The (b) compound includes the ones given above, and particularly preferred one is one or more compound selected from the group consisting of ethylene oxide, 1,3-dioxolane, 1,4-butanediol formal, and diethylene glycol formal.

A specifically preferred (c) multifunctional glycidylether compound is the one having 3 to 4 glycidylether groups in a single molecule. Examples of the preferable (c) multifunctional glycidylether compound are trimethylol propane triglycidylether, glycerol triglycidylether, and pentaerythritol tetraglycidylether. The method for preparing the (A2) polyacetal resin having branched or crosslinked molecular structure is not specifically limited, and, similar to the preparation of (A1) polyacetal resin, known methods can be applied.

According to the present invention, the mixing ratio of the (A2) polyacetal resin having branched or crosslinked molecular structure is in a range from 0.1 to 20 parts by weight to 100 parts by weight of the (A1) polyacetal resin. If the amount of (A2) polyacetal resin is small, the improvement in the mechanical characteristics becomes insufficient. If the amount of (A2) polyacetal resin is excessive, the moldability and other characteristics deteriorate, which results in insufficient mechanical characteristics. Preferred mixing rates of the (A2) polyacetal resin are 0.2 to 10 parts by weight to 100 parts by weight of the (A1) polyacetal resin, and more preferred rates are from 0.3 to 5 parts by weight.

The polyacetal resin composition according to the present invention is a mixture of above-described (A1) and (A2) polyacetal resins with (B) lubricant oil keeping liquid state at 200° C. Examples of preferable (B) lubricant oil are silicone-based oil, polyalkylene glycol, α-olefin oligomer, paraffin oil, alkyl-substituted diphenylether, and an ester of a higher aliphatic alcohol. Individual lubricant oils are described below in detail.

Typical examples of preferred silicone-based oil are the ones expressed by the following formula (1), such as polydimethyl siloxane or polymethylphenyl siloxane. 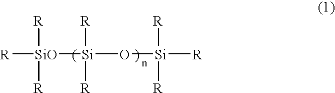
where R is methyl group, and a part thereof may be other alkyl group, phenyl group, halogenated alkyl group, and halogenated phenyl group, and n is arbitrary integer.

Although the viscosity of silicone oil according to the present invention is not specifically limited, a preferable range thereof is from 100 to 100,000 cSt (25° C.) of dynamic viscosity considering totally the sliding performance, the sustainability of sliding performance, the dispersibility of oil into the resin, and the workability during melting and kneading and during molding. According to the present invention, two or more kinds of silicone oils having different structure or viscosity from each other may be mixed to use, and further a thickener, a solvent, and the like may be added to the silicone oil to adjust the viscosity thereof.

The polyalkylene glycol is a lubricant oil which has a structure of single or random, block, or graft copolymerization of polyethylene glycol unit or polypropylene glycol unit, and which is obtained by ring-opening polymerization of alkylene oxide composed mainly of ethylene oxide and propylene oxide. Regarding that type of polyalkylene glycol, a derivative thereof obtained by etherification or esterification of the terminal hydroxyl group. Typical ester or ether derivatives include: a compound having a structure of esterified bond or etherified bond of C8 or higher aliphatic carboxylic acid or aliphatic alcohol, respectively, to the terminal hydroxyl group of the polyalkylene glycol; and an ether or the like of polyhydric alcohol such as glycerin, polyglycerin or sorbitan, with polyalkylene glycol. According to the present invention, specifically preferably used ester or ether derivatives are: polypropylene glycol having average molecular weights ranging from 400 to 5000; copolymer of polyethylene glycol and polypropylene glycol; ester of these alkylene glycols and C12 or higher fatty acid represented by lauric acid and stearic acid; and ether of C12 or higher aliphatic alcohol represented by stearyl alcohol.

The α-olefin oligomer is an aliphatic hydrocarbon having a structure of mainly a single C6 to C20 α-olefin or of copolymer of ethylene with C3 to C20 α-olefin. According to the present invention, ethylene-α-olefin oligomer having number average molecular weights ranging from 400 to 4000 is preferable.

The paraffin oil is what is called the “paraffin-based mineral oil” which is obtained by refining petroleum fraction.

The alkyl-substituted diphenylether is a compound expressed by the formula (2), having a structure that at least one kind of C12 or higher saturated aliphatic chain in a substituent form selected from the group consisting of alkyl group, ester group, and ether group, is introduced into the phenyl of diphenylether. There is no specific limitation in the molecular weight of the alkyl-substituted diphenylether, and any kind of alkyldiphenylether is preferred. Although that kind of substituent many be introduced into any position of the phenyl group, an alkyl-substituted diphenylether preferably has the substituent at any of 2, 4, 6, 2′, 4′, and 6′ from the point of synthesis, and particularlly preferably a two-position substituted compound at 4,4′ positions. 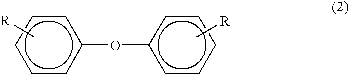
where, R is alkyl group, ether group, or ester group, which is introduced into some or whole of the 2-6 positions and 2′-6′ positions.

Applicable substituent for the alkyl-substituted diphenylether includes: straight chain alkyl group such as dodecyl group, tetradecyl group, hexadecyl group or octadecyl group; and branched alkyl group expressed by the following formula (3). 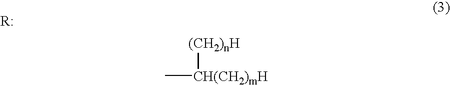
where, n and m are each 0 or larger integer, and n+m≧11.

Examples of the ester group are dodecyloxy carbonyl group, tetradecyloxy carbonyl group, hexadecyloxy carbonyl group, octadecyloxy carbonyl group, lauroyl oxy group, myristoyl oxy group, palmitoyl oxy group, and stearoyl oxy group. Examples of the ether group are lauryloxy group, myristyloxy group, palmityloxy group, and stearyloxy group. Furthermore, the ester group or the ether group may be a derivative of isostearyl alcohol and isostearic acid, in which the aliphatic hydrocarbon chain of the ester group or the ether group has a branched molecular structure.

The ester of higher aliphatic alcohol is an ester of higher aliphatic alcohol with a monovalent saturated fatty acid or dibasic acid, and practically preferred one is an ester of a saturated aliphatic alcohol having 16 or larger number of carbon atoms with a saturated fatty acid having 16 or larger carbon atoms and/or a polybasic acid. Examples of the saturated fatty alcohol having 16 or larger number of carbon atoms are cetyl alcohol, stearyl alcohol, isostearyl alcohol, behenyl alcohol, erucic alcohol, hexyldecyl alcohol, and octyidodecyl alcohol. Examples of the fatty acid having 16 or larger number of carbon atoms are straight-chain or branched unsaturated fatty acids such as palmitic acid, stearic acid, isostearic acid, arachidic acid, behenic acid or montanic acid. These esters of monovalent fatty acid and monovalent aliphatic alcohol are preferably used. Examples of the dibasic acid structuring the ester by combining with the above-described aliphatic alcohol having 16 or larger number of carbon atoms are phthalic acid, adipic acid, sebacic acid, and trimellitic acid. The above esters of dibasic acid and aliphatic alcohol are preferably a full ester in view of maintaining the thermal stability of polyacetal. As of these aliphatic esters composed of carboxylic acid and alcohol, particularly preferred ones are, in view of price, availability (synthesis and purification), and friction and abrasion characteristics, stearyl stearate, behenyl behenate, distearyl adipate, and distearyl phthalate. According to the present invention, one or more of the above aliphatic esters are preferably used.

According to the present invention, the (B) lubricant oil is added to 100 parts by weight of (A1) polyacetal resin by the amounts from 0.05 to 20 parts by weight, thereby improving the friction and abrasion characteristics. If the added amount of the (B) lubricating oil is less than 0.05 parts by weight, the effect of reducing the friction factor cannot fully be attained, and, if the added amount thereof exceeds 20 parts by weight, the moldability and the friction characteristics are extremely reduced, both of which are not preferable. More preferred adding amount of the (B) lubricant oil is in a range from 0.5 to 5 parts by weight.

The polyacetal resin composition according to the present invention may further contain various known stabilizers and additives. The applicable stabilizer includes one or more of hindered phenol-based compound, nitrogen-containing compound such as melamine, guanamine, hydrazide or urea, hydroxide of alkali or alkali earth metal, inorganic salt, carboxylic acid salt, and the like. The applicable additive may be a general additive to thermoplastic resin, which additive includes one or more coloring agent such as dye or pigment, lubricant, nucleation agent, releasing agent, anti-static agent or and surfactant.

Furthermore, other than the glass-based filler, one or more of known fillers of inorganic, organic, and metallic fillers in fibrous, plate, powder, or granular shape can be added within an amount range that does not significantly deteriorate the molding article performance which is an object of the present invention. Examples of those fillers are talc, mica, wollastonite, and carbon fiber. However, the applicable fillers are not limited to these examples.

The composition according to the present invention is easily prepared by a known method commonly used for preparing conventional resin composition. For example: individual components are mixed together, and the mixture is kneaded and extruded through a single screw extruder or a twin screw extruder to prepare pellets thereof, and then the pellets are molded; pellets having different compositions from each other are prepared, (master batch), and the specified quantities of the respective pellets are mixed, (dilution), to mold, and then the molding article having the desired composition is attained.

On preparing the composition, a preferred method to improve the dispersibility of the additives is that a portion or total of the polyacetal resin which is the base component is pulverized, which pulverized resin is then mixed with other component, followed by extrusion or other treatment.

### EXAMPLES

The present invention is described in more detail in the following referring to Examples. The present invention, however, is not limited by these Examples. The evaluation was conducted by the following methods.

(Melt Index)

Melt index was determined in accordance with ASTM D-1238 under the condition of 190° C. and 2160 g load.

(Copolymer Composition)

The copolymer composition was determined by ¹H-NMR using hexafluoroisopropanol d2 as the solvent.

<Tensile Strength and Tensile Breaking Strain>

Tensile strength and tensile breaking strain were determined in accordance with ISO527, after allowing the tensile test piece (per ISO 3167) to standing at 23° C. and 50% RH for 48 hours.

<Friction Factor>

Dynamic friction factor after slid for 24 hours was determined by a Suzuki Friction Abrasion Tester under 0.75 kg/cm² of pressing force, 180 mm/sec of line speed, and 2.0 cm² of contact area, using a polyacetal resin material (DURACON™ M90-44, manufactured by Polyplastics Co., Ltd.) as the mating material.

<Preparation of (A1) Polyacetal Resin>

Applied was a continuous mixing reactor having an external jacket for heating (cooling) medium, a barrel in a cross section of part-overlapping two circles, and two rotary shafts with paddles. While rotating each of the two rotary shafts provided with paddles at 150 rpm, (a) trioxane and (b) 1,3-dioxolane were charged to the reactor by the amount of (a)/(b)=98.3% by weight/1.7% by weight. Methylal was continuously charged as the molecular weight adjuster. Furthermore, boron trifluoride as the catalyst was continuously added to the reactants by the amount of 0.005% by weight to the quantity of trioxane, thereby conducting the bulk polymerization. The reaction products were discharged from the reactor, and were promptly charged to a crusher, and then were immediately introduced into an aqueous solution of 0.05% by weight of triethylamine at 60° C., thereby deactivating the catalyst. Through the treatment of separation, washing, and drying, a crude polyacetal resin was obtained.

To 100 parts by weigh of thus obtained crude polyacetal resin, 3% by weight of an aqueous solution of 5% by weight of triethylamine, and 0.3% by weight of pentaerythrityl tetrakis[3-(3,5-di-tert-butyl-4-hydroxyphenyl)propionate] were added. The mixture was melted and kneaded in a twin screw extruder at 210° C. to remove instable moiety, thus obtaining a polyacetal resin in pellet shape, having 26.8 g/10 min of melt index (MI). The polyacetal resin pellets were used for preparing the polyacetal resin composition.

<Preparation of (A2) Polyacetal Resin>

The manufacturing method and the composition of the branched or crosslinked polyacetal resin which is the (A2) component are described below.

Applied was a continuous mixing reactor having an external jacket for heating (cooling) medium, a barrel in a cross section of part-overlapping two circles, and two rotary shafts with paddles. While rotating each of the two rotary shafts provided with paddles at 150 rpm, (a) trioxane, (b) a compound selected from a monofunctional cyclic ether compound and a monofunctional cyclic formal compound, and (c) a polyfunctional glycidylether compound, were charged to the reactor at the respective ratios given in Table 1. Methylal was continuously charged as the molecular weight adjuster. Furthermore, boron trifluoride as the catalyst was continuously added to the reactants by the amount of 0.005% by weight to the quantity of trioxane, thereby conducting the bulk polymerization. The reaction products were discharged from the reactor, and were promptly charged to a crusher, and then immediately were introduced into an aqueous solution of 0.05% by weight of triethylamine at 60° C., thereby deactivating the catalyst. Through the treatment of separation, washing, and drying, a crude polyacetal resin was obtained.

To 100 parts by weigh of thus obtained crude polyacetal resin, 3% by weight of an aqueous solution of 5% by weight of triethylamine, and 0.3% by weight of pentaerythrityl tetrakis[3-(3,5-di-tert-butyl-4-hydroxyphenyl)propionate] were added. The mixture was melted and kneaded in a twin screw extruder at 210° C. to remove instable moiety, thus obtaining a polyacetal resin in pellet shape. The polyacetal resin pellets were used for preparing the polyacetal resin composition.

Composition and melt index of these polyacetal resins are shown in Table 1. The abbreviations given in Table 1 are as follows.

(b) Component

DO: 1,3-dioxolan

BF: 1,4-butandiol formal

(c) Component

TMPTGE: trimethylolpropane triglycidylether

TABLE 1

| | | Trioxane | Compound | | Compound | | |
|---|---|---|---|---|---|---|---|
| | Polyacetal | (a) | (b) | | (c) | | Melt index MI |
| | resin No. | (wt. %) | Kind | (wt %) | Kind | (wt %) | (g/10 min) |
| Production | A2-1 | 98.2 | DO | 1.7 | TMPTGE | 0.1 | 1.5 |
| Example 1 | | | | | | | |
| Production | A2-2 | 98.2 | BF | 1.7 | TMPTGE | 0.1 | 0.9 |
| Example 2 | | | | | | | |
| Production | A2-3 | 98.0 | DO | 1.7 | TMPTGE | 0.3 | 0.9 |
| Example 3 | | | | | | | |

### EXAMPLES 1 TO 34, COMPARATIVE EXAMPLES 1 TO 17

To the (A1) polyacetal resin, following-given various lubricant oils (B1 to B8) and crosslinked polyacetal resins (A2-1 to A2-3) were added at the respective ratios given in Table 2 and Table 3. The respective mixtures were melted and kneaded in an extruder at 200° C. of cylinder temperature to obtain the respective compositions in pellet shape. Using an injection molding machine, test pieces were prepared by molding each of the pellet compositions to evaluate the physical properties. The results are given in Table 2 and Table 3.

For comparison, there were prepared pellet composition without adding the crosslinked polyacetal and pellet composition without adding the lubricant oil. Physical properties of these comparative compositions were also evaluated. The results are given in Table 4.

TABLE 2

| | Examples | | | | | | | | |
|---|---|---|---|---|---|---|---|---|---|
| | 1 | 2 | 3 | 4 | 5 | 6 | 7 | 8 | 9 |
| (A1) POM resin | 100 | 100 | 100 | 100 | 100 | 100 | 100 | 100 | 100 |
| (parts by weight) | | | | | | | | | |
| (B) Lubricant oil | B-1 | B-1 | B-1 | B-1 | B-1 | B-1 | B-2 | B-2 | B-2 |
| (parts by weight) | 1 | 1 | 1 | 3 | 3 | 3 | 1 | 1 | 1 |
| (A2) Crosslinked | A2-1 | A2-1 | A2-1 | A2-1 | A2-1 | A2-1 | A2-1 | A2-1 | A2-1 |
| POM resin | 1 | 3 | 5 | 1 | 3 | 5 | 1 | 3 | 5 |
| (parts by weight) | | | | | | | | | |
| Sliding performance | 0.25 | 0.24 | 0.25 | 0.17 | 0.18 | 0.17 | 0.17 | 0.16 | 0.17 |
| (friction factor after | | | | | | | | | |
| 24 hours of sliding) | | | | | | | | | |
| Tensile strength | 63.3 | 65.1 | 66.2 | 58.1 | 60.0 | 62.4 | 63.5 | 66.0 | 67.7 |
| (MPa) | | | | | | | | | |
| Tensile breaking | 35 | 30 | 26 | 40 | 35 | 31 | 30 | 24 | 19 |
| strain (%) | | | | | | | | | |
| | Examples | | | | | | | | |
| | 10 | 11 | 12 | 13 | 14 | 15 | 16 | 17 | 18 |
| (A1) POM resin | 100 | 100 | 100 | 100 | 100 | 100 | 100 | 100 | 100 |
| (parts by weight) | | | | | | | | | |
| (B) Lubricant oil | B-2 | B-2 | B-2 | B-3 | B-3 | B-3 | B-3 | B-3 | B-3 |
| (parts by weight) | 3 | 3 | 3 | 0.5 | 0.5 | 0.5 | 1 | 1 | 1 |
| (A2) Crosslinked | A2-1 | A2-1 | A2-1 | A2-1 | A2-1 | A2-1 | A2-1 | A2-1 | A2-1 |
| POM resin | 1 | 3 | 5 | 1 | 3 | 5 | 1 | 3 | 5 |
| (parts by weight) | | | | | | | | | |
| Sliding performance | 0.15 | 0.14 | 0.14 | 0.26 | 0.25 | 0.24 | 0.20 | 0.19 | 0.18 |
| (friction factor after | | | | | | | | | |
| 24 hours of sliding) | | | | | | | | | |
| Tensile strength | 59.1 | 60.7 | 62.6 | 63.1 | 65.8 | 68.0 | 61.6 | 63.0 | 64.9 |
| (MPa) | | | | | | | | | |
| Tensile breaking | 34 | 30 | 23 | 32 | 27 | 23 | 33 | 28 | 25 |
| strain (%) | | | | | | | | | |

TABLE 3

| | Examples | | | | | | | |
|---|---|---|---|---|---|---|---|---|
| | 19 | 20 | 21 | 22 | 23 | 24 | 25 | 26 |
| (A1) POM resin | 100 | 100 | 100 | 100 | 100 | 100 | 100 | 100 |
| (parts by weight) | | | | | | | | |
| (B) Lubricant oil | B-4 | B-4 | B-5 | B-5 | B-6 | B-6 | B-7 | B-7 |
| (parts by weight) | 1 | 1 | 1 | 1 | 1 | 1 | 1 | 1 |
| (A2) Crosslinked | A2-1 | A2-1 | A2-1 | A2-1 | A2-1 | A2-1 | A2-1 | A2-1 |
| POM resin | 3 | 5 | 3 | 5 | 3 | 5 | 3 | 5 |
| (parts by weight) | | | | | | | | |
| Sliding performance | 0.24 | 0.23 | 0.18 | 0.17 | 0.25 | 0.25 | 0.20 | 0.20 |
| (friction factor after | | | | | | | | |
| 24 hours of sliding) | | | | | | | | |
| Tensile strength | 64.6 | 66.6 | 61.9 | 64.0 | 62.1 | 64.8 | 61.7 | 63.7 |
| (MPa) | | | | | | | | |
| Tensile breaking | 27 | 23 | 34 | 28 | 31 | 26 | 30 | 26 |
| strain (%) | | | | | | | | |
| | Examples | | | | | | | |
| | 27 | 28 | 29 | 30 | 31 | 32 | 33 | 34 |
| (A1) POM resin | 100 | 100 | 100 | 100 | 100 | 100 | 100 | 100 |
| (parts by weight) | | | | | | | | |
| (B) Lubricant oil | B-8 | B-8 | B-1 | B-1 | B-2 | B-2 | B-3 | B-3 |
| (parts by weight) | 1 | 1 | 1 | 1 | 1 | 1 | 1 | 1 |
| (A2) Crosslinked | A2-1 | A2-1 | A2-2 | A2-3 | A2-2 | A2-3 | A2-2 | A2-3 |
| POM resin | 3 | 5 | 3 | 3 | 3 | 3 | 3 | 3 |
| (parts by weight) | | | | | | | | |
| Sliding performance | 0.23 | 0.22 | 0.24 | 0.23 | 0.17 | 0.18 | 0.21 | 0.20 |
| (friction factor after | | | | | | | | |
| 24 hours of sliding) | | | | | | | | |
| Tensile strength | 62.1 | 64.0 | 63.5 | 63.8 | 65.4 | 65.2 | 62.7 | 62.3 |
| (MPa) | | | | | | | | |
| Tensile breaking | 33 | 27 | 30 | 31 | 25 | 23 | 28 | 28 |
| strain (%) | | | | | | | | |

TABLE 4

| | Comparative Examples | | | | | | | | |
|---|---|---|---|---|---|---|---|---|---|
| | 1 | 2 | 3 | 4 | 5 | 6 | 7 | 8 | 9 |
| (A1) POM resin | 100 | 100 | 100 | 100 | 100 | 100 | 100 | 100 | 100 |
| (parts by weight) | | | | | | | | | |
| (B) Lubricant oil | | B-1 | B-1 | B-2 | B-2 | B-3 | B-3 | B-4 | B-5 |
| (parts by weight) | | 1 | 3 | 1 | 3 | 0.5 | 1 | 1 | 1 |
| (A2) Crosslinked | | | | | | | | | |
| POM resin | | | | | | | | | |
| (parts by weight) | | | | | | | | | |
| Sliding performance | 0.34 | 0.24 | 0.17 | 0.17 | 0.14 | 0.25 | 0.21 | 0.23 | 0.18 |
| (friction factor after | | | | | | | | | |
| 24 hours of sliding) | | | | | | | | | |
| Tensile strength | 64.0 | 61.0 | 56.9 | 61.8 | 58.7 | 62.0 | 60.1 | 61.5 | 60.2 |
| (MPa) | | | | | | | | | |
| Tensile breaking | 35 | 42 | 50 | 35 | 38 | 35 | 36 | 36 | 39 |
| strain (%) | | | | | | | | | |

| | Comparative Examples | | | | | | | |
|---|---|---|---|---|---|---|---|---|
| | 10 | 11 | 12 | 13 | 14 | 15 | 16 | 17 |
| (A1) POM resin | 100 | 100 | 100 | 100 | 100 | 100 | 100 | 100 |
| (parts by weight) | | | | | | | | |
| (B) Lubricant oil | B-6 | B-7 | B-8 | | | | | |
| (parts by weight) | 1 | 1 | 1 | | | | | |
| (A2) Crosslinked | | | | A2-1 | A2-1 | A2-1 | A2-2 | A2-3 |
| POM resin | | | | 1 | 3 | 5 | 3 | 3 |
| (parts by weight) | | | | | | | | |
| Sliding performance | 0.25 | 0.19 | 0.22 | 0.34 | 0.33 | 0.33 | 0.34 | 0.34 |
| (friction factor after | | | | | | | | |
| 24 hours of sliding) | | | | | | | | |
| Tensile strength | 59.2 | 60.0 | 59.9 | 66.0 | 68.0 | 70.0 | 67.0 | 68.0 |
| (MPa) | | | | | | | | |
| Tensile breaking | 37 | 34 | 38 | 27 | 24 | 23 | 25 | 27 |
| strain (%) | | | | | | | | |

B-1: Polydimethyl siloxane (5,000 cSt, SH-200, Toray Dow Corning Silicone Co., Ltd. or Dow Corning Toray Co., Ltd.)
B-2: α-Olefin oligomer (900 cSt, LUCANT HC40, Mitsui Petrochemical Industries, Ltd. or Mitsui Chemical Corporation)
B-3: Stearyl stearate
B-4: Distearyl adipate
B-5: Polypropylene glycol (580 cSt, PP3000, Sanyo Chemical Industries, Ltd.)
B-6: Ethylene glycol-propylene glycol copolymer (1700 cSt, 50HB-5100, Sanyo Chemical Industries, Ltd.)
B-7: Paraffin oil (1000 cSt, Process oil, Idemitsu Kosan Co., Ltd.)
B-8: Alkyl-substituted diphenylether (200 cSt, MORESCO HILUBE, Matsumura Oil Research Corp.)

1. A polyacetal resin composition comprising: (A1) 100 parts by weight of a polyacetal resin having substantially straight chain molecular structure; (A2) 0.1 to 20 parts by weight of a polyacetal resin having branched or crosslinked molecular structure; and (B) 0.05 to 20 parts by weight of a lubricant oil keeping liquid state at 200° C.

2. The polyacetal resin composition as in claim 1, wherein the (B) lubricant oil is selected from the group consisting of a silicone-base oil, a polyalkylene glycol, an α-olefin oligomer, a paraffin oil, an alkyl-substituted diphenylether, and an ester of higher aliphatic alcohol, having kinematic viscosities from one hundred to one hundred thousand centistokes (at 25° C.).

3. The polyacetal resin composition as in claim 1 or claim 2, wherein the (A1) polyacetal resin is prepared by copolymerization of (a) 99.9 to 90.0% by weight of trioxane and (b) 0.1 to 10.0% by weight of a compound selected from a cyclic ether compound having no substituent and a cyclic formal compound having no substituent, and the (A1) polyacetal resin is a copolymer having melt indexes from 1 to 50 g/min.

4. The polyacetal resin composition as in claim 1, wherein the (A2) polyacetal resin is prepared by copolymerization of (a) 99.89 to 88.0% by weight of trioxane, (b) 0.1 to 10.0% by weight of a compound selected from a cyclic ether compound having no substituent and a cyclic formal compound having no substituent, and (c) 0.01 to 2.0% by weight of a multifunctional glycidylether compound, and the (A2) polyacetal resin is a copolymer of crosslinked polyacetal having melt indexes from 0.1 to 10 g/min.

5. The polyacetal resin composition as in claim 4, wherein the (c) multifunctional glycidylether compound has three or four glycidyl groups.

6. The polyacetal resin composition as in claim 4, wherein the (c) multifunctional glycidylether compound is selected from the group consisting of a trimethylol propane triglycidylether, a glycerol triglycidylether, and a pentaerythritol tetraglycidylether.

7. The polyacetal resin composition as in claim 3, wherein the (b) compound is one or more compounds selected from the group consisting of ethylene oxide, 1,3-dioxolane, 1,4-butanediol formal, and diethylene glycol formal.
